(19) United States
(12) Patent Application Publication
(10) Pub. No.: US 2010/0285881 A1
(43) Pub. Date: Nov. 11, 2010

(54) TOUCH GESTURING ON MULTI-PLAYER GAME SPACE

(75) Inventor: Charles Bilow, North Bend, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/437,352

(22) Filed: May 7, 2009

(51) Int. Cl. A63F 9/24; A63F 13/00

(52) U.S. Cl. 463/37

(57) ABSTRACT

Touch gesturing on a multi-player game space is herein provided. One example method of managing a multi-player game displayed via a touch display includes recognizing a touch input directed to a position of the multi-player game space. In response, the method may include instantiating a player space occupying a portion of the multi-player game space including the position of the first touch input. The method may further include recognizing a second touch input within the player space, and in response, moving the player space to follow the second touch input. In some embodiments, the method may further include resizing the player space.

### BACKGROUND

Computing devices with touch displays capable of detecting user inputs in the form of touch inputs and touch gestures are becoming increasingly common. Such devices may be configured to detect inputs from a single user and/or multiple users. Further, touch displays may be vertically-orientated such as, for example, computer monitors and wall-mounted touch-screens. Alternatively, touch displays may have other orientations such as touch displays included in laptop computers, personal digital assistants, mobile phones, tablet computers, table-top displays, and the like.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

Touch gesturing on a multi-player game space is herein provided. One example method of managing a multi-player game displayed via a touch display includes instantiating a player space occupying a portion of the multi-player game space upon recognizing a touch input directed to a position of the multi-player game space. Such player spaces may be resized or repositioned via subsequent touch inputs and/or touch gestures, thus accommodating dynamic rearrangement or addition of new players.

### BRIEF DESCRIPTION OF THE DRAWINGS

FIG. 1 shows a schematic depiction of game players interacting with an embodiment of a computing system with a touch display.

FIG. 2 shows a flow diagram of an example method of managing a multi-player game played on a horizontally-orientated touch display.

FIG. 3 shows a schematic depiction of instantiating a player space of a multi-player game on a horizontally-orientated touch display, in accordance with an embodiment of the present disclosure.

FIG. 4 shows a schematic depiction of moving a player space of a multi-player game on a horizontally-orientated touch display, in accordance with an embodiment of the present disclosure.

FIG. 5 shows a schematic depiction of instantiating a new player space on a horizontally-orientated touch display, in accordance with an embodiment of the present disclosure.

FIG. 6 shows another schematic depiction of instantiating a new player space on a horizontally-orientated touch display, in accordance with an embodiment of the present disclosure.

FIG. 7 shows a schematic depiction of grab targets displayed on a horizontally-orientated touch display, in accordance with an embodiment of the present disclosure.

FIG. 8 shows a schematic depiction of a game object placed on a horizontally-orientated touch display, in accordance with an embodiment of the present disclosure.

FIG. 9 shows an example embodiment of a computing system with a touch display.

### DETAILED DESCRIPTION

The present disclosure is related to a multi-player game space visually presented on a touch display. The touch display may be configured to allow interaction with several game players by displaying a multi-player game space including individual player spaces corresponding to each player. Such a multi-player game space may be used to display a variety of interactive multi-player games, such as card games, puzzle games, dice games, word games, party games, arcade games, role-playing games, first-person games, third-person games, and the like. Since such games are popular in social settings, it is likely that the number of players may fluctuate often, and therefore the multi-player game space can be configured to easily accommodate the addition of new players. Accommodating such players may include adjusting a size or position of existing player spaces to make room for a new player space. Thus, such a multi-player game space not only accommodates addition/subtraction of players on the fly, but can also dynamically accommodate a variety of seating arrangements. Further, by including a player space associated with each player, each player may control their own playing area and may change a size, orientation or position of their player space for personal preference, as well as for accommodating other players.

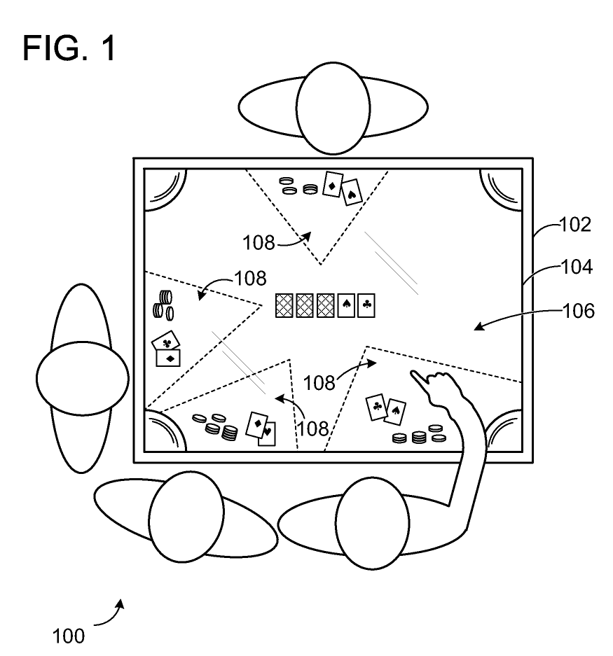

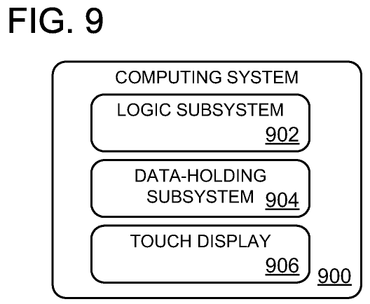

As an example, FIG. 1 shows a schematic depiction of game players 100 interacting with an embodiment of a computing system 102 including an embodiment of a touch display 104. Touch display 104 may display an embodiment of a multi-player game space 106 and embodiments of player spaces 108, where each player space 108 occupies a portion of multi-player game space 106. As depicted, touch display 104 is a horizontally-orientated touch display. However, such an orientation is shown for the purpose of illustration, and it will be understood that touch display 104 may alternatively be a vertically-orientated touch display or a touch display with a changeable orientation. As an example of a touch display with a changeable orientation, a computing system in accordance with the present disclosure may be a portable computing device. Computing system 102 may further include a logic subsystem and a data-holding subsystem, as described in more detail with reference to FIG. 9.

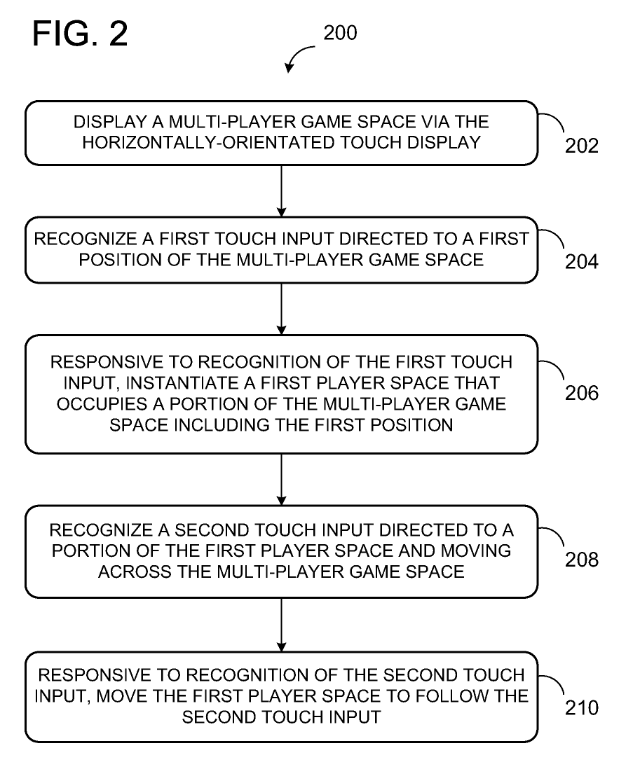

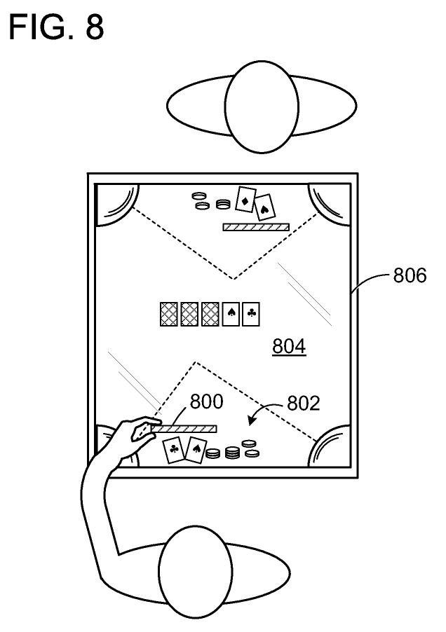

FIG. 2 shows a flow diagram of an embodiment of a method 200 of managing a multi-player game played with a horizontally-orientated touch display. Again, while described with reference to a horizontally-orientated touch display, it is to be understood that the method may be applied with a touch display having any other orientation. At 202, method 200 includes displaying a multi-player game space via the horizontally-orientated touch display. The multi-player game space may be configured to be further subdivided into single-player spaces and/or shared spaces, as described in more detail hereafter. The touch display displaying the multi-player game space may be configured to detect touch inputs in any suitable manner, such as using capacitive detection, optical detection, resistive detection, etc. Such touch inputs may be from a player's finger, a stylus, or any other such implement capable of interacting with the touch display. Touch inputs may also be from a physical object sitting on the display (e.g., a privacy shield object) as described in more detail with reference to FIG. 8.

Touch inputs detectable by the touch display may include gesture-based touch inputs such as swipe gestures, flick gestures, circular gestures, finger taps, drag-and-drop gestures, press-and-hold gestures, and the like. Further, the touch display may be configured to detect multi-touch gestures, including a two-finger or three-finger swipe, tap, etc. Such multi-touch gestures may also include pinch and/or stretch gestures of two fingers (or a finger and thumb, etc.) moved towards each other in a “pinching” motion or away from each other in a “stretching” motion.

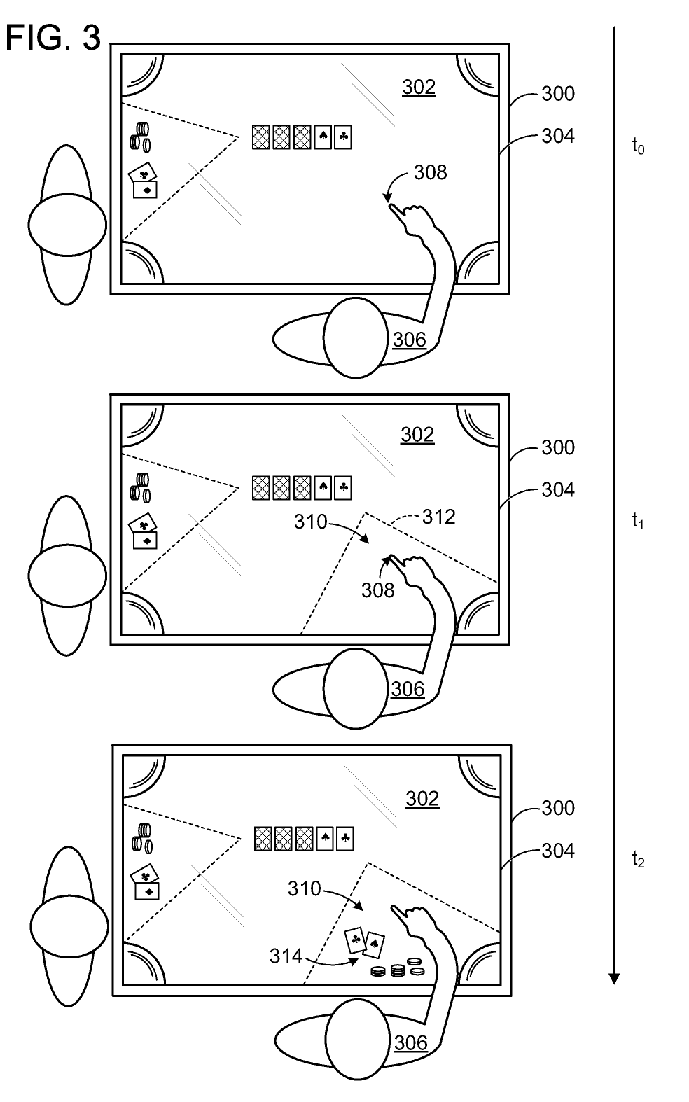

At 204, method 200 includes recognizing a first touch input directed to a first position of the multi-player game space. As described above, a first touch input may be, for example, a touch input from a player's fingertip. As another example, the first touch input may be a touch-and-hold gesture. As an example, FIG. 3 shows a touch sequence of a computing system 300 displaying a multi-player game space 302 via a horizontally-orientated touch display 304. At time t₀, a first touch input of player 306 directed to a first position 308 of multi-player game space 302 may be recognized.

Returning to FIG. 2, at 206 method 200 includes responsive to recognition of the first touch input, instantiating a first player space that occupies a portion of the multi-player game space including the first position. Such a first player space may be associated with a first player interacting with the multi-player gaming space. The first player space may be a game play area associated with the first player, which the first player may utilize during game play. For example, in a card game, the player space may be used to display a player's cards, chips, game score, etc. In another example, a player space of a word game may be used to display a player's letter tiles. In yet another example, a player space of a strategy game may be used to display a player's score and a clock displaying the time remaining for that player's turn. In yet another example, a player space of a geometric game may be used to display a player's remaining geometric tiles to be played. In yet another example, a player space of a dice game may display virtual dice which a player may “roll” via a gesture-based touch input within the player space.

Player spaces may be of any suitable size, shape, configuration etc. as described in more detail as follows. For example, in some embodiments, a player space may be visually defined on the display, for example by displaying a shading of the player space, displaying an outlining of a border of the player space, etc. to visually indicate the first player space. In other embodiments, a player space may not be visually defined on the display.

In some embodiments, player spaces may each be of a same size. Alternatively, in other embodiments, player spaces may be sized differently relative to one another. In some embodiments, player spaces may be arranged symmetrically within a multi-player game space. Alternatively, in other embodiments, player spaces may be arranged asymmetrically to accommodate virtually any seating configuration of players. Furthermore, in some embodiments, each player space may radiate from a central location of the multi-player game space. In some embodiments, each player space may be substantially pie shaped. However, in other embodiments, player spaces may be of a substantially different shape, such as rectangular, circular, etc.

As an example, at time t₁ of the touch sequence depicted in FIG. 3, responsive to recognition of the first touch input by player 306, a first player space 310 is instantiated such that first player space 310 occupies a portion of multi-player game space 302 including first position 308. In the embodiment depicted in FIG. 3, first player space 310 is visually defined on touch display 304 by a border 312. As depicted at time t₂, first player space 310 displays, at 314, virtual cards and virtual chips corresponding to player 306.

Returning to FIG. 2, at 208 method 200 includes recognizing a second touch input directed to a portion of the first player space and moving across the multi-player game space. For example, a player may perform a touch-and-drag gesture on the display, where the touch gesture is directed to any portion of the first player space or a specific portion of the first player space, followed by a drag gesture across the multi-player game space.

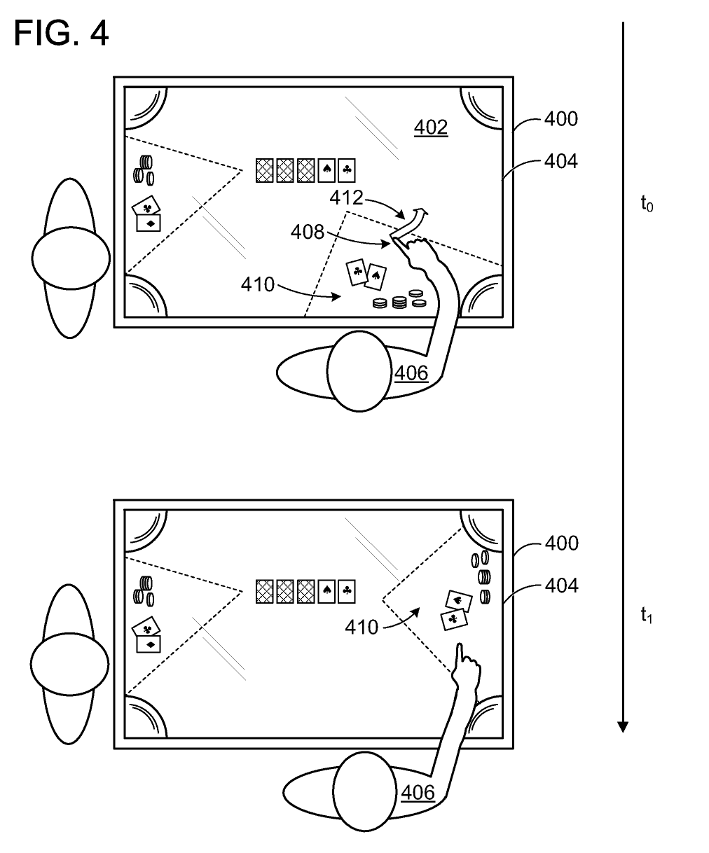

At 210, method 200 includes responsive to recognition of the second touch input, moving the first player space to follow the second touch input. In other words, the second touch input directed to a portion of the first player space and moving across the multi-player game space can be used to translate the first player space to another location of the multi-player game space. As an example, FIG. 4 shows a touch sequence of a computing system 400 displaying a multi-player game space 402 via a horizontally-orientated touch display 404. At time t₀, a second touch input of player 406 directed to a portion 408 of the first player space 410 may be recognized. As depicted by the arrow at 412, the second touch input is recognized to be moving across the multi-player game space 402. Responsive to such recognition, at time t₁ the first player space 410 may be moved to follow the second touch input.

In some embodiments, method 200 may further include recognizing subsequent touch inputs, where each subsequent touch input may be directed to a position of the multi-player game space exterior to existing player spaces. Further, responsive to recognition of such a subsequent touch input, a new player space may be instantiated such that the new player space occupies a portion of the multi-player game space including the position to which that subsequent touch input was directed. For example, a new player may decide to join a game already in progress by touching the multi-player game space at a location external to the existing player spaces. Upon recognizing the new touch input, a new player space may be created for the new player.

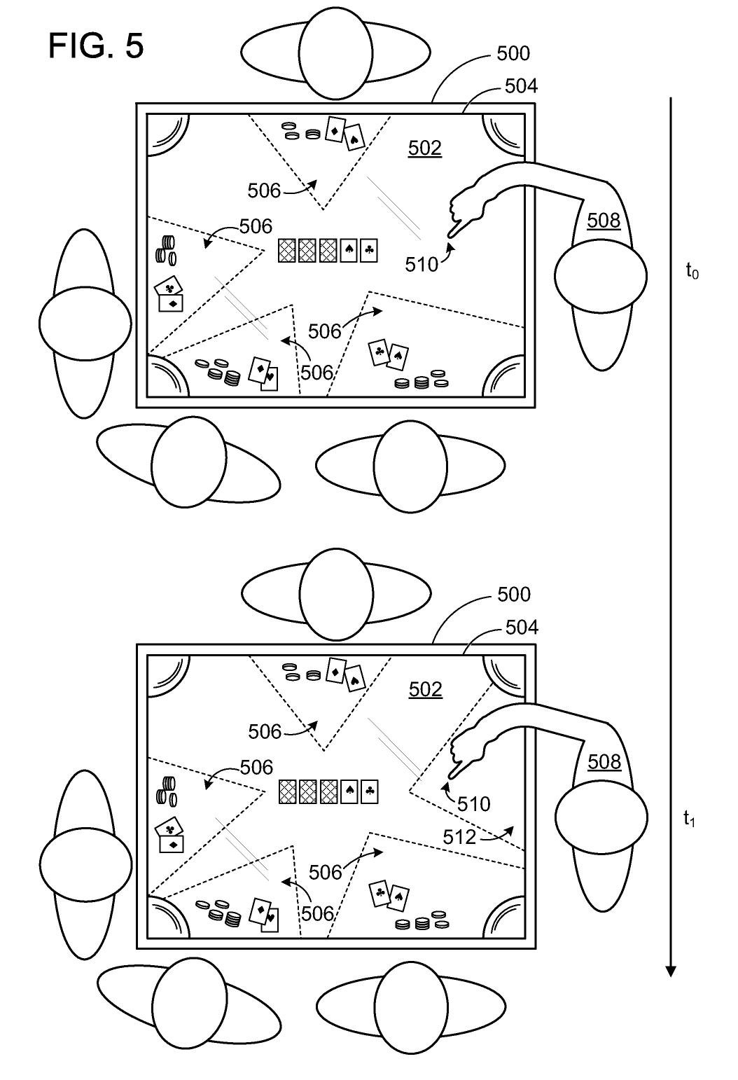

As an example, FIG. 5 shows a touch sequence of a computing system 500 displaying a multi-player game space 502 via a horizontally-orientated touch display 504. Multi-player game space 502 includes existing player spaces 506. At time t₀, a subsequent touch input of a new player 508 directed to a position 510 of multi-player game space 502, external to existing player spaces 506, may be recognized. In response, a new player space 512 may be instantiated, as depicted at time t₁ of the touch sequence, such that new player space 512 includes position 510.

Further, instantiating a new player space as described above may further include decreasing a size of one or more existing player spaces to accommodate the new player space. Additionally or alternatively, instantiating a new player space may include shifting a position of one or more existing player spaces to accommodate the new player space. Such growing, shrinking, and/or moving of existing player spaces may be done at any time during the game.

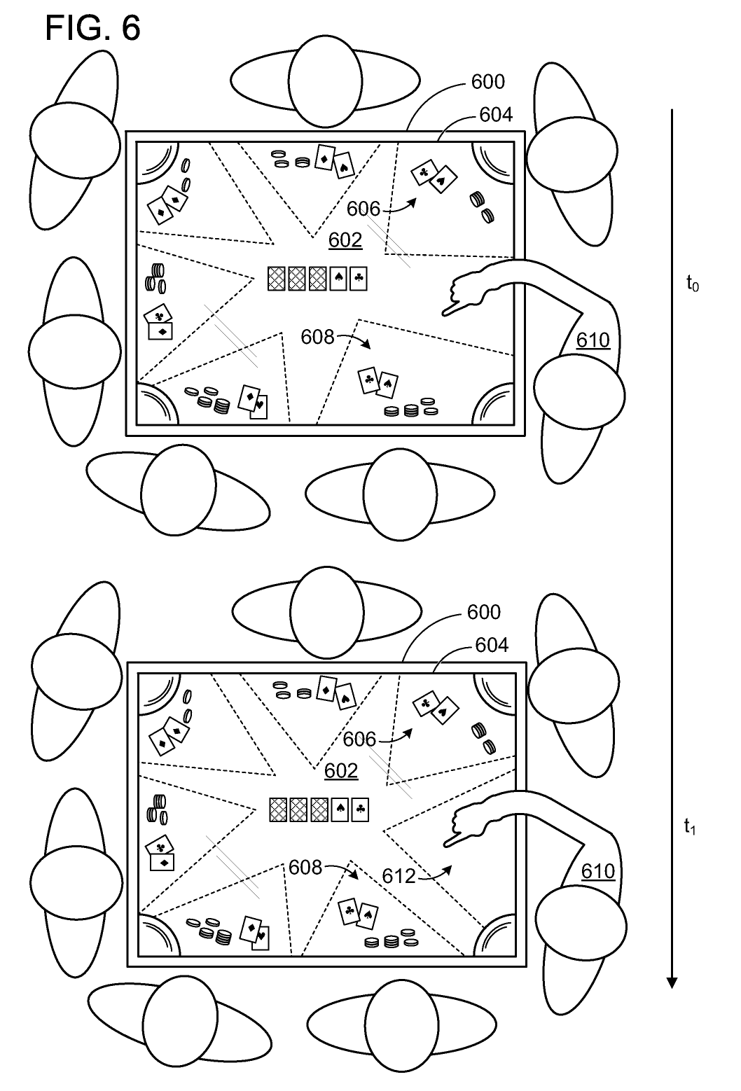

As an example, FIG. 6 shows a touch sequence of a computing system 600 displaying a multi-player game space 602 via a horizontally-orientated touch display 604. Multi-player game space 602 includes several existing player spaces, such as existing player space 606 and existing player space 608. At time t₀, a subsequent touch input of a new player 610 may be recognized. In response, a new player space 612 is instantiated, as depicted at time t₁. Moreover, to accommodate new player space 612, existing player spaces 606 and 608 have decreased in size and shifted in position.

In some embodiments, a player space may further include a grab target. Accordingly, the touch display may be configured to recognize a touch input directed at such a grab target and moving across the multi-player game space. In some embodiments, in response to recognizing such a touch input directed at the grab target, the player space may be moved to follow the touch input. Alternatively, in some embodiments, in response to recognizing such a touch input directed at the grab target, a size of the player space may be changed.

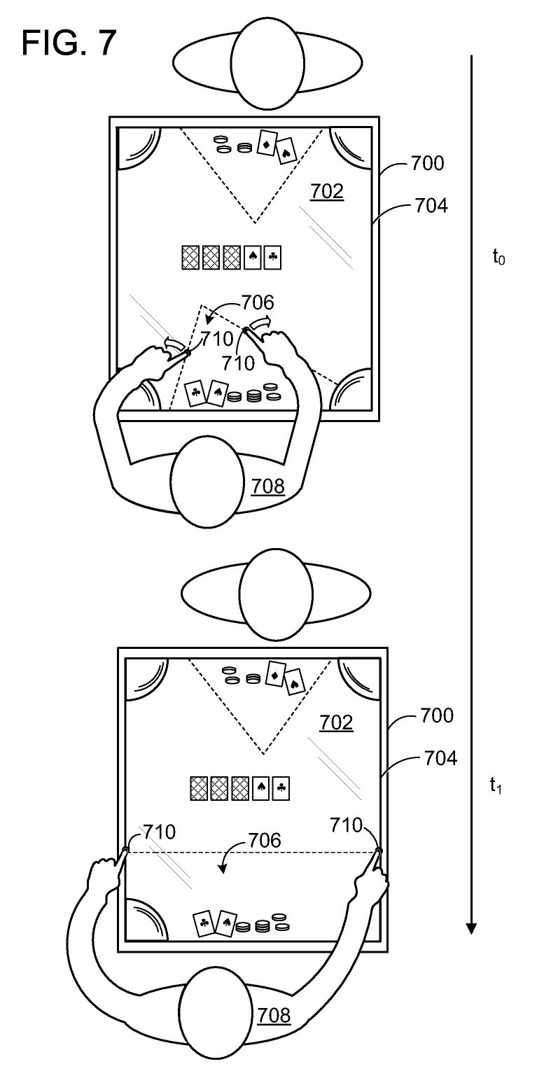

FIG. 7 shows an example of resizing a player space using an embodiment of a grab target. At time t₀ of the depicted touch sequence, a computing system 700 displays a multi-player game space 702 via a horizontally-orientated touch display 704. Multi-player game space 702 includes a player space 706. As further shown at time t₀, player 708 directs touch inputs to grab targets 710. Upon recognizing the touch inputs moving across the multi-player game space 702, touch display 704 displays a changing in the size of player space 706 as shown at time t₁.

The touch input directed at the grab target may be any suitable touch input, such as the touch-and-drag inputs described above, and described with reference to FIG. 3. Further, in some embodiments, the recognized touch input may be a stretch or pinch gesture. The grab targets may take a variety of different forms without departing from the spirit of this disclosure. Nonlimiting examples of grab targets includes, grab bars located at a peripheral region of a player space, grab icons located at a perimeter of a player space, or game objects located interior a player space. In some embodiments, the grab targets may be distinctively patterned, colored, or otherwise visually depicted to signify their functionality.

As described herein, the multi-player game space may include one or more player spaces. However, the multi-player game space may further include a shared space external to the player spaces. Such a shared space may include, for example, chips and/or a dealer's hand in a virtual card game, a virtual game board, a scoreboard, a clock, etc. Moreover, as described above with reference to the player spaces changing in size and/or location to accommodate the addition of more player spaces, such a shared space may likewise adjust in size, shape, and/or location.

Further, graphic images and information visually presented in such shared spaces or player spaces may change in response to the space increasing or decreasing in size. As an example, under size constraints, a space (i.e. a shared space and/or a player space) may display a dollar value of chips rather than a graphical image of stacks of chips. As another example, a size of each virtual playing card may decrease as the space decreases.

In some embodiments, a touch input recognized by the touch display may include a touch input from a game object placed on the touch display. Adjustments in size, location, shape, etc. of player spaces may track motion of the game object on the display just as in the case of tracking other touch inputs. For example, a game object may execute a first touch input when placed on the touch display, and the game object may execute a second touch input when the game object is moved across the touch display. In some cases, the game object may be a privacy shield (e.g. a visor) configured to limit visibility of a portion of a player space. A player may use such a game object to limit visibility of their cards, game pieces, etc. from their opponents. Such cards, game pieces, etc. may be moved in response to a change in location of the game object. As an example, FIG. 8 shows a schematic representation of a game object 800, used within player space 802 of multi-player game space 804 on touch display 806.

Further, in some embodiments, game objects may be “tagged” with a barcode, etc. detectable by the touch display. Such a tagged game object may be a token preconfigured to be associated with a player's profile, such that the player may join a game by setting the tagged game object on the display, upon which the computing system obtains the player profile and optionally displays stored settings (e.g. winnings) associated with the player. In this way, a player may move from one multi-player game to another while information pertaining to the player is automatically transferred from one computing system to the other.

In some embodiments, the above described methods and processes may be tied to a computing system. As an example, FIG. 9 schematically shows a computing system 900 that may perform one or more of the above described methods and processes. Computing system 900 includes a logic subsystem 902, a data-holding subsystem 904, and a touch display 906.

Logic subsystem 902 may include one or more physical devices configured to execute one or more instructions. For example, the logic subsystem may be configured to execute one or more instructions that are part of one or more programs, routines, objects, components, data structures, or other logical constructs. Such instructions may be implemented to perform a task, implement a data type, transform the state of one or more devices, or otherwise arrive at a desired result. The logic subsystem may include one or more processors that are configured to execute software instructions. Additionally or alternatively, the logic subsystem may include one or more hardware or firmware logic machines configured to execute hardware or firmware instructions. The logic subsystem may optionally include individual components that are distributed throughout two or more devices, which may be remotely located in some embodiments.

Data-holding subsystem 904 may include one or more physical devices configured to hold data and/or instructions executable by the logic subsystem to implement the herein described methods and processes. When such methods and processes are implemented, the state of data-holding subsystem 904 may be transformed (e.g., to hold different data). Data-holding subsystem 904 may include removable media and/or built-in devices. Data-holding subsystem 904 may include optical memory devices, semiconductor memory devices, and/or magnetic memory devices, among others. Data-holding subsystem 904 may include devices with one or more of the following characteristics: volatile, nonvolatile, dynamic, static, read/write, read-only, random access, sequential access, location addressable, file addressable, and content addressable. In some embodiments, logic subsystem 902 and data-holding subsystem 904 may be integrated into one or more common devices, such as an application specific integrated circuit or a system on a chip.

Computing system 900 may further include touch display 906, which may be used to present a visual representation of data held by data-holding subsystem 904. As the herein described methods and processes change the data held by the data-holding subsystem, and thus transform the state of the data-holding subsystem, the state of touch display 906 may likewise be transformed to visually represent changes in the underlying data. Touch display 906 may include one or more display devices utilizing virtually any type of technology. Such display devices may be combined with logic subsystem 902 and/or data-holding subsystem 904 in a shared enclosure, or such display devices may be peripheral display devices.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A method of managing a multi-player game played with a horizontally-orientated touch display, the method comprising:
displaying a multi-player game space via the horizontally-orientated touch display;
recognizing a first touch input directed to a first position of the multi-player game space;
responsive to recognition of the first touch input, instantiating a first player space that occupies a portion of the multi-player game space including the first position;
recognizing a second touch input directed to a portion of the first player space and moving across the multi-player game space; and
responsive to recognition of the second touch input, moving the first player space to follow the second touch input.

2. The method of claim 1, further comprising recognizing subsequent touch inputs, each subsequent touch input directed to a position of the multi-player game space exterior existing player spaces; and responsive to recognition of a subsequent touch input, instantiating a new player space that occupies a portion of the multi-player game space including the position to which that subsequent touch input was directed.

3. The method of claim 2, where a size of one or more existing player spaces decreases to accommodate the new player space.

4. The method of claim 2, where a position of one or more existing player spaces shifts to accommodate the new player space.

5. The method of claim 2, where each player space radiates from a central location of the multi-player game space.

6. The method of claim 5, where each player space is substantially pie shaped.

7. The method of claim 1, where a peripheral region of the first player space includes a grab target.

8. The method of claim 7, where the second touch input is directed to the grab target.

9. The method of claim 7, further comprising recognizing a third touch input directed to the grab target; and responsive to recognition of the third touch input, changing a size of the first player space.

10. The method of claim 9, where the third touch input includes a stretch or pinch gesture.

11. The method of claim 1, where the first touch input is a touch-and-hold gesture.

12. The method of claim 1, where a game object executes the first touch input when the game object is placed on the horizontally-orientated touch display; and where the game object executes the second touch input when the game object is moved across the horizontally-orientated touch display.

13. The method of claim 12, where the game object is a privacy shield configured to limit visibility of a portion of the first player space.

14. A computing system, comprising:
a touch display;
a logic subsystem; and
a data-holding subsystem holding instructions executable by the logic subsystem to:
display a multi-player game space via the touch display;
recognize a first touch input directed to a first position of the multi-player game space;
responsive to recognition of the first touch input, instantiate a first player space that occupies a portion of the multi-player game space including the first position;
recognize subsequent touch inputs, each subsequent touch input directed to a position of the multi-player game space exterior to existing player spaces; and
responsive to recognition of a subsequent touch input, instantiating a new player space that occupies a portion of the multi-player game space including the position to which that subsequent touch input was directed.

15. The method of claim 14, where the data-holding subsystem further includes instructions executable by the logic subsystem to recognize a second touch input directed to a portion of the first player space and moving across the multi-player game space: and responsive to recognition of the second touch input, moving the first player space to follow the second touch input.

16. A method of managing a multi-player game played with a horizontally-orientated touch display, the method comprising:
displaying a multi-player game space via the horizontally-orientated touch display;
recognizing a first touch input directed to a first position of the multi-player game space;
responsive to recognition of the first touch input, instantiating a first player space that occupies a portion of the multi-player game space including the first position, a peripheral region of the first player space including a first grab target;
recognizing a second touch input directed to a second position of the multi-player game space exterior the first player space;
responsive to recognition of the second touch input, instantiating a second player space that occupies a portion of the multi-player game space including the second position, a peripheral region of the second player space including a second grab target;
recognizing a third touch input directed to the first grab target and moving across the multi-player game space; and
responsive to recognition of the third touch input, moving the first player space to follow the third touch input.

17. The method of claim 16, where each player space radiates from a central location of the multi-player game space.

18. The method of claim 16, further comprising recognizing subsequent touch inputs, each subsequent touch input directed to a position of the multi-player game space exterior to existing player spaces; and responsive to recognition of a subsequent touch input, instantiating a new player space that occupies a portion of the multi-player game space including the position to which that subsequent touch input was directed.

19. The method of claim 18, where a size of one or more existing player spaces decreases to accommodate the new player space.

20. The method of claim 18, where a position of one or more existing player spaces shifts to accommodate the new player space.
